(19) United States
(12) Patent Application Publication
(10) Pub. No.: US 2023/0235763 A1
(43) Pub. Date: Jul. 27, 2023

(54) ASSEMBLY HAVING DISCRETIZED AND SEGMENTED JOINT ARCHITECTURE

(71) Applicant: Divergent Technologies, Inc., Los Angeles, CA (US)

(72) Inventors: Bahram ISSARI, Laguna Niguel, CA (US); Shahan Soghomon KASNAKJIAN, Los Angeles, CA (US); Eric Paul MONTEITH, Long Beach, CA (US); Lukas Philip CZINGER, Santa Monica, CA (US); Samuel Noah MILLER, Marina Del Rey, CA (US); Chor Yen YAP, Gardena, CA (US); Matthew Cooper KELLER, Marina Del Rey, CA (US)

(21) Appl. No.: 18/159,583

(22) Filed: Jan. 25, 2023

Related U.S. Application Data
(60) Provisional application No. 63/302,985, filed on Jan. 25, 2022.

(51) Int. Cl. F16B 7/04; F16B 11/00

(52) U.S. Cl. CPC F16B 7/0406; F16B 11/008

(57) ABSTRACT

The present aspects include an assembly having discretized and segmented joint architecture. The assembly comprises a first structure including an outer wall and an inner wall, wherein the outer wall and the inner wall extend from a base of the first structure, and define a groove, and a plurality of connecting walls extending between the outer wall and the inner wall such that the groove is divided into a plurality of groove segments defined by the outer wall, the inner wall, and the plurality of connecting walls. The assembly further comprises a second structure including a plurality of tongue segments which extend into the plurality of groove segments. A first adhesive is inserted into the groove, thereby bonding the plurality of tongue segments within the plurality of groove segments such that the first and second structures are fixed together.

### CROSS-REFERENCE TO RELATED APPLICATIONS

This application claims priority to U.S. Provisional Application No. 63/302,985 titled “DISCRETIZED AND SEGMENTED JOINT ARCHITECTURE,” filed Jan. 25, 2022, which is assigned to the assignee hereof, and incorporated by reference in its entirety as if fully set forth herein.

### TECHNICAL FIELD

The present disclosure generally relates to an attachment structure also referred to as a joint or segmented joint, and more particularly to an attachment structure that incorporates tongue-and-groove features to realize a structural connection.

### BACKGROUND

Joints are used to connect structures together into an assembly in a multitude of manufacturing processes. For instance, one or more structures may be joined in space frame construction for automotive, structural, marine, and many other applications. One example of space frame construction can be a welded frame chassis construction, often used in low volume and high performance vehicle. These assemblies require that structures of the chassis be connected at a wide variety of angles and may require the same connection point to accommodate a variety of geometries. Traditional methods fabrication of attachment structures for connection of such chassis may incur high equipment and manufacturing costs, as such attachment structures are often complicated to cast or machine.

Thus, improvements are desired in the design and manufacture of joint and assembly structures.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, the present aspects include a joint between two components, which includes segmented joints incorporating tongue-and-groove features to realize a structural connection. The groove-side includes walls that segment the entire groove into multiple groove segments. The walls may have a varying height ranging from a fraction of the groove depth to the height of the groove. The tongue-side includes segmented tongues that correspond to each of the segmented grooves.

In an aspect, more specifically, an assembly, comprises a first structure including an outer wall and an inner wall, wherein the outer wall and the inner wall extend from a base and define a groove, and a plurality of connecting walls extending between the outer wall and the inner wall such that the groove is divided into a plurality of groove segments defined by the outer wall, the inner wall, and the plurality of connecting walls; a second structure including a plurality of tongue segments extending into the plurality of groove segments; and a first adhesive in the groove, the first adhesive bonding the plurality of tongue segments in the plurality of groove segments such that the first and second structures are fixed together.

Another example aspect includes an assembly wherein a first tongue segment of the plurality of tongue segments extends a first distance, and wherein a second tongue segment of the plurality of tongue segments extends a second distance less than the first distance.

Another example aspect includes an assembly wherein the groove includes a curved section of the groove, wherein at least one of the plurality of connecting walls is located within the curved section.

Another example aspect includes an assembly wherein the groove includes a curved section, wherein at least one of the plurality of connecting walls is located outside of the curved section.

Another example aspect includes an assembly wherein a first groove segment and a second groove segment of the plurality of groove segments respectively have a first groove length and a second groove length, wherein the first groove length is greater than the second groove length.

Another example aspect includes an assembly wherein a first tongue segment and a second tongue segment of the plurality of tongue segments are respectively aligned with the first groove segment and the second groove segment, and wherein the first tongue segment and the second tongue segment respectively have a first tongue length and a second tongue length, wherein the first tongue length is greater than the second tongue length, and wherein the first tongue length is sized to fit within the first groove segment and the second tongue length is sized to fit within the second groove segment.

Another example aspect includes an assembly wherein each of the plurality of groove segments have a same groove segment length.

Another example aspect includes an assembly wherein each of the plurality of tongue segments have a same tongue length and are configured to fit within a respective one of the plurality of groove segments.

Another example aspect includes an assembly wherein the first structure further includes a plurality of second connecting walls extending between the outer wall and the inner wall such that the groove is further divided into a plurality of second groove segments defined by the outer wall, the inner wall, and the plurality of second connecting walls, the second structure further includes a plurality of second tongue segments extending into the plurality of second groove segments, and a second adhesive in the second groove segments, wherein the second adhesive is a faster-curing adhesive than the first adhesive, the second adhesive bonding the plurality of second tongue segments in the plurality of second groove segments.

Another example aspect includes an assembly wherein the second adhesive includes an ultraviolet (UV) cured adhesive.

Another example aspect includes an assembly wherein the outer wall includes openings to the second groove segments, the openings being configured to allow a UV light to expose and cure the second adhesive.

Another example aspect includes an assembly wherein one or more of the plurality of connecting walls extend to a bottom of the groove.

Another example aspect includes an assembly, wherein one or more of the plurality of connecting walls does not extend to a bottom of the groove..

Another example aspect includes an assembly wherein at least one of the plurality of connecting walls includes an opening between adjacent ones of the plurality of groove segments.

Another example aspect includes an assembly wherein the opening includes at least a mesh or a fork.

Another example aspect includes an assembly wherein the outer wall extends further than the inner wall.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is an isometric view of an example segmented joint according an aspect of the disclosure.

FIG. 2 is an isometric view of a second embodiment of an example segmented joint according an aspect of the disclosure.

FIG. 3 is an isometric view of a third embodiment of an example segmented joint according an aspect of the disclosure.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

Aspects of the disclosure include an assembly or assembly mechanism, e.g., a discretized or segmented joint, having multiple attachment features.

In one example implementation, which should not be construed as limiting, the assembly mechanism may include at least a first structure and a second structure configured to attach to one another, thereby forming a joint. The first structure includes a groove, which is configured to receive a tongue of a second structure. The second structure is then fixed within the first structure by injecting an adhesive or bonding agent within the groove before or after inserting the tongue into the groove to secure tongue of the second structure within the groove of the first structure.

In an additional example implementation the groove of the first structure may be broken up into a plurality of groove segments, by a plurality of internal walls, within the first structure. Similarly, the tongue of the second structure may be broken up into a plurality of tongue segments, which correspond to the plurality of groove segments. The plurality of tongue segments of the second structure may then be inserted into the plurality of groove segments of the first structure and are subsequently fixed within the first structure by injecting an adhesive or bonding agent within the plurality of groove segments. The use of a plurality of groove segments and a corresponding plurality of tongue segments allows for the formation of a discretized or segmented joint structure.

The described segmented joint structure provides numerous advantages over traditional joint structures. First, the use of a segmented joint structure may increase the entire structure's robustness to contamination by isolating the contamination to discrete joint segments, and further may increase the entire structure's robustness to premature failures related to adhesive voids by isolating the voids to each discretized joint segment. Second, the segmented joint may terminate crack propagation at each individual segment, which in turn will improve overall fatigue performance and durability of the adhesive joint. Third, the segmented joint structure may improve resistance to corrosion related failures by terminating corrosion ingress at each segment. Fourth, segmented joints may allow for the application of two or more adhesives within the bonded assembly. For example, one adhesive may be a structural adhesive with great performance at lower temperatures, and a second adhesive may contribute to adequate performance of the joint at high temperatures, with the combination meeting and surpassing structural requirements for the bonded assembly. Lastly, the use of multiple groove segments and tongue segments may provide increased accuracy in the manufacturing process as well as increased flexibility of the tongue segments, which in turn can make the assembly process easier and more efficient.

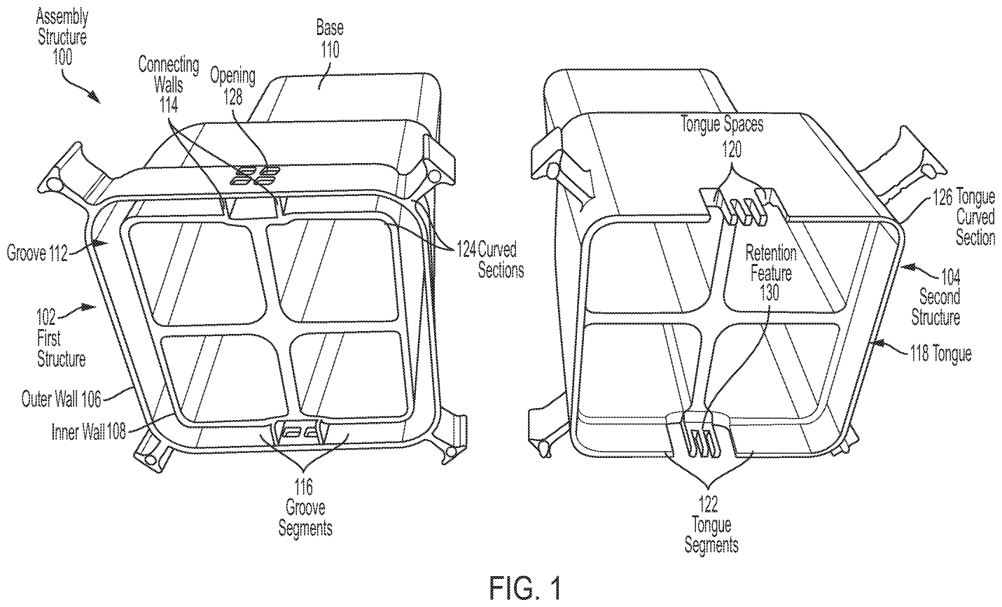

Referring to FIG. 1, in one example implementation that should not be construed as limiting, an assembly 100 includes a first structure 102 and a second structure 104 each having multiple attachment features configured to connect the first structure 102 to the second structure 104, and thereby form a segmented joint. Consequently, the assembly 100, also referred to herein as a joint or segmented joint, may be used to connect multiple different structures, such as in space frame construction applications.

The first structure 102 of the assembly 100 includes an outer wall 106 and an inner wall 108. The outer wall 106 and the inner wall 108 extend from a base 110 of the first structure 102, and include a space between the outer wall 106 and inner wall 108 which defines a groove 112. As can be seen in FIG. 1 the outer wall 106 may extend a first distance from the base 110 and the inner wall 108 may extend a second distance less than the first distance from the base 110 so that the outer wall 106 extends further than the inner wall 108.

The first structure may further include a plurality of connecting walls 114, which extend between the outer wall 106 and the inner wall 108. The plurality of connecting walls 114 divide the groove 112 into a plurality of groove segments 116. The groove segments 116 are therefore defined by the combination of the outer wall 106, inner wall 108 and the plurality of connecting walls 114.

The second structure 104 of the assembly 100 includes a tongue 118 which extends from the second structure 104. The tongue 118 may be separated by a plurality of tongue spaces or notches 120, which divide the tongue 118 into a plurality of tongue segments 122.

The outer wall 106 of the first structure 102 has a first set of dimensions, and the inner wall 108 of the first structure 102 has a second set of dimensions, smaller than those of the first set of dimensions of the outer wall 106, which together define the size of the groove 112 and in turn the size of the plurality of groove segments 116. The dimensions of the outer wall 106 and inner wall 108 may be adjusted to make the groove 112 and plurality of groove segments 116 smaller or larger based on the requirements of a particular application. The tongue 118 has a third set of dimensions smaller than the first set of dimensions of the outer wall 106 and larger than the second set of dimensions of the inner wall 108. This allows for the tongue 118 and plurality of tongue segments 122 to fit within the groove 112 and plurality of groove segments 116. Further, each tongue segment of the plurality of tongue segments 122 corresponds to a respective groove segment of the plurality of groove segments 116, so as to allow each tongue segment 122 to be inserted into a groove segment 116. For example, if the first structure 102 includes four groove segments 116 as is shown in FIG. 1, then the second structure would include four tongue segments 122, which would each correspond to, and be insertable into, one of the four groove segments 116. An adhesive or bonding element can then be inserted into the groove segments 116 to secure each tongue segment of the plurality of tongue segments 122 into each corresponding groove segment of the plurality of groove segments 116, thereby securing the first structure 102 to the second structure 104 and creating a segmented joint assembly 100.

In an additional example implementation, each tongue segment 122 of the plurality of tongue segments 122 may extend a different distance into each corresponding groove segment 116 of the plurality of groove segments 116. For example one tongue segment 122 may extend a first distance into the groove 112 and a second tongue segment 122 may extend a second distance into the groove, different from the first distance. This allows for customization of the plurality of tongue segments 122 to fit different structural needs of the segmented join assembly 100.

In a further example implementation, the number of connecting walls 114 may be increased or decreased, which in turn increases or decreases the number of groove segments 116 and tongue segments 122 as can be seen across FIGS. 1-3. Additionally, connecting walls 114 may be placed equidistant from one another to allow for uniform groove segments 116 and corresponding uniform tongue segments 122. In a further example, the connecting walls 114 may be placed in a non-equidistant manner so that the groove segments 116 are of varying sizes. Similarly, each of the tongue segments 122 corresponds to each of the groove segments 116 and may therefore be uniform in size or of varying size based on the structure and architecture of the corresponding groove segments 116. Changing the number, size, and uniformity of the groove segments 116 and respective tongue segments 122, changes the structural integrity of the assembly 100, and allows for customization of the segmented joint assembly 100 for different applications, during which the joint may incur different loads and stresses in different locations of the joint assembly 100.

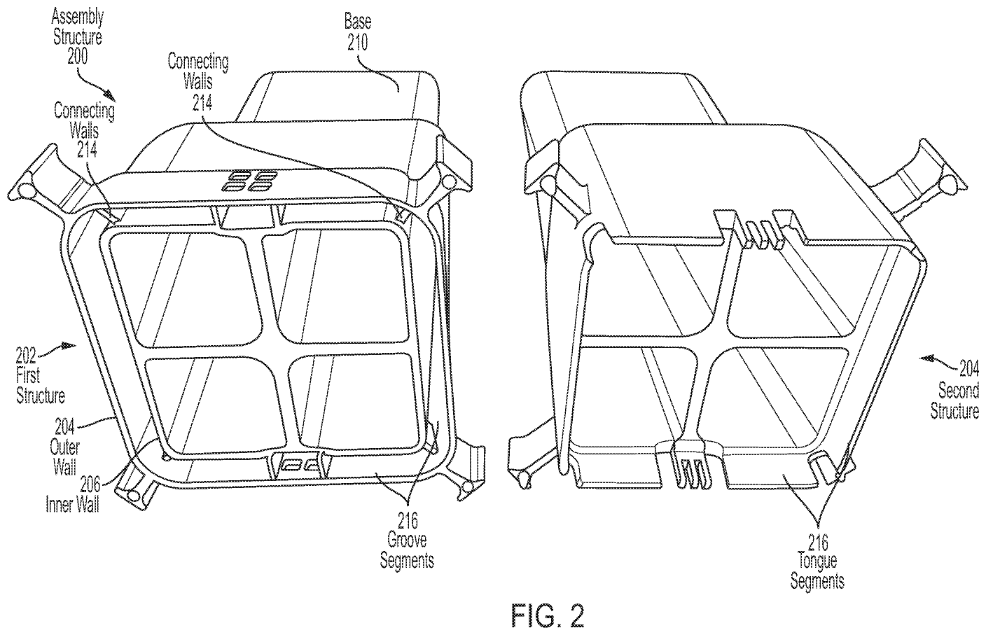

Referring to FIG. 2, an assembly structure 200 is shown. An outer wall 204 and an inner wall 206 of the first structure 202 may include a plurality of curved sections 224. In an example implementation, at least one of a plurality of connecting walls 214 may extend between the curved sections 224 of the outer wall 204 and the inner wall 206. This allows at least one of the corresponding groove segments of a plurality of groove segments 216 to include only a portion of respective curved sections 224 of the outer wall 204 and the inner wall 206 of the first structure 202. Accordingly, each of the respective tongue segments 222 of a plurality of tongue segments 222 would therefore be divided at a corresponding tongue curved section 226 of a tongue 218.

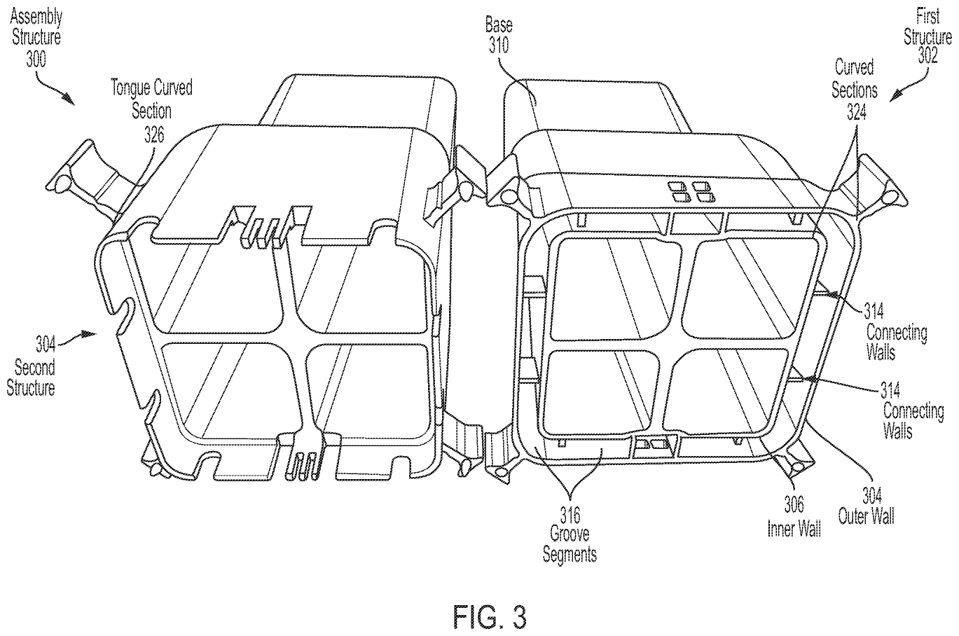

Referring to FIG. 3, an assembly structure 300 is shown. An outer wall 304 and an inner wall 306 of a first structure 302 include a plurality of curved sections 324. In an additional example implementation, a plurality of connecting walls 314 may be located on either side of each of the respective curved sections 324 of the outer wall 304 and the inner wall 306 of the first structure 302. This allows for some or all of groove segments of a plurality of groove segments 316 to include the entirety of each of the respective curved sections 324 of the outer wall 304 and the inner wall 306 of the first structure 302. Accordingly, each of a respective tongue segments 322 of the plurality of tongue segments 322 would therefore include a corresponding tongue curved section 326 of a tongue 318.

In example implementations as shown in FIGS. 1-3, when attaching the first structure to the second structure, the tongue or plurality of tongue segments of the second structure are inserted into the corresponding groove or plurality of groove segments. An adhesive can be injected into the groove or plurality of groove segments, prior to or after insertion, to secure the first structure to the second structure, and to secure the tongue or plurality of tongue segments within the groove or corresponding plurality of groove segments.

In an example aspect, at least one of the plurality of connecting walls extend to the bottom of the groove. In various embodiments, at least one of the plurality of connecting walls may extend from the top of the groove all the way to the bottom of the groove. This would separate the respective groove segments on either side of the connecting wall from fluidly communicating with one another. In this aspect each groove segment could be attached to the corresponding tongue segment utilizing a different adhesive or other means of attachment. For example, a first tongue segment of the plurality of tongue segments may be adhered to a respective first groove segment of the plurality of groove segments utilizing a first adhesive, which has a first cure rate, or a first heating temperature. A second tongue segment of the plurality of tongue segments may be adhered to a respective second groove segment of the plurality of groove segments utilizing a second adhesive, which has a second cure rate, or a second heating temperature. Further an additional groove segment may be filled with an electrically conductive substance or any other substance that may be relevant or necessary to a particular application. This creates different structural properties across the various segmented groove segments and allows for different adhesive mechanisms to be applied across the various segmented groove segments. The separation of each groove segment of the plurality of groove segments from the additional groove segments therefore allows for a high level variance to account for different applications of the segmented joint assembly.

In an additional aspect one or more of the plurality of connecting walls may not extend from the top of the groove all the way to the bottom of the groove, and/or may not extend from the bottom of the groove all the way to the top of the groove. In other words one or more of the plurality of connecting walls may not extend the full length of the groove. This implementation allows for fluid communication between adjacent groove segments within the groove. For example, if two or more adjacent groove segments within the groove utilize the same adhesive or method of adhering, fluid communication between adjacent groove segments may be allowed while still maintaining the benefits of segmentation between the groove segments. In a further example one or more of the plurality of connecting walls may be constructed of a mesh or similar structure, which would allow for an additional means of fluid communication between adjacent groove segments, while still maintaining the benefits of segmentation between the groove segments.

In an additional aspect the outer wall of at least one of the plurality of groove segments may include a window or opening. The opening of the outer wall may allow an ultraviolet (UV) light to expose and cure the adhesive injected into the respective groove segment. The corresponding tongue segment may further include a retention feature, such as a fork structure, to accept a quick-cure UV adhesive and to subsequently retain the first structure to the second structure as structural adhesive curing is applied. Additionally, the opening may further allow adjacent groove segments within the groove, which utilize the same adhesive, and, which are in fluid communication with one another to similarly be cured using UV light.

In the above aspects, the assembly may be 3-D printed. This allows for small complex structures to be created much more easily, many of which cannot feasibly be created through the use of standard machining. This allows for the groove segments and tongue segments to be highly variable and therefore allows for different load bearing combinations, which may be more acceptable in different applications.

1. An assembly, comprising:
a first structure including an outer wall and an inner wall, wherein the outer wall and the inner wall extend from a base and define a groove, and a plurality of connecting walls extending between the outer wall and the inner wall such that the groove is divided into a plurality of groove segments defined by the outer wall, the inner wall, and the plurality of connecting walls;
a second structure including a plurality of tongue segments extending into the plurality of groove segments; and
a first adhesive in the groove, the first adhesive bonding the plurality of tongue segments in the plurality of groove segments such that the first and second structures are fixed together.

2. The assembly of claim 1, wherein a first tongue segment of the plurality of tongue segments extends a first distance, and wherein a second tongue segment of the plurality of tongue segments extends a second distance less than the first distance.

3. The assembly of claim 1, wherein the groove includes a curved section of the groove, wherein at least one of the plurality of connecting walls is located within the curved section.

4. The assembly of claim 1, wherein the groove includes a curved section, wherein at least one of the plurality of connecting walls is located outside of the curved section.

5. The assembly of claim 1, wherein a first groove segment and a second groove segment of the plurality of groove segments respectively have a first groove length and a second groove length, wherein the first groove length is greater than the second groove length.

6. The assembly of claim 5, wherein a first tongue segment and a second tongue segment of the plurality of tongue segments are respectively aligned with the first groove segment and the second groove segment, and wherein the first tongue segment and the second tongue segment respectively have a first tongue length and a second tongue length, wherein the first tongue length is greater than the second tongue length, and wherein the first tongue length is sized to fit within the first groove segment and the second tongue length is sized to fit within the second groove segment.

7. The assembly of claim 1, wherein each of the plurality of groove segments have a same groove segment length.

8. The assembly of claim 1, wherein each of the plurality of tongue segments have a same tongue length and are configured to fit within a respective one of the plurality of groove segments.

9. The assembly of claim 1, wherein the first structure further includes a plurality of second connecting walls extending between the outer wall and the inner wall such that the groove is further divided into a plurality of second groove segments defined by the outer wall, the inner wall, and the plurality of second connecting walls, the second structure further includes a plurality of second tongue segments extending into the plurality of second groove segments, and a second adhesive in the second groove segments, wherein the second adhesive is a faster-curing adhesive than the first adhesive, the second adhesive bonding the plurality of second tongue segments in the plurality of second groove segments.

10. The assembly of claim 9, wherein the second adhesive includes an ultraviolet (UV) cured adhesive.

11. The assembly of claim 10, wherein the outer wall includes openings to the second groove segments, the openings being configured to allow a UV light to expose and cure the second adhesive.

12. The assembly of claim 1, wherein one or more of the plurality of connecting walls extend to a bottom of the groove.

13. The assembly of claim 1, wherein one or more of the plurality of connecting walls does not extend to a bottom of the groove.

14. The assembly of claim 1, wherein at least one of the plurality of connecting walls includes an opening between adjacent ones of the plurality of groove segments.

15. The assembly of claim 14, wherein the opening includes at least a mesh or a fork.

16. The assembly of claim 1, wherein the outer wall extends further than the inner wall.
